(19) United States
(12) Patent Application Publication
(10) Pub. No.: US 2008/0133847 A1
(43) Pub. Date: Jun. 5, 2008

(54) VOID EXTENT METHOD FOR DATA INTEGRITY ERROR HANDLING

(76) Inventors: John Mark Morris, San Diego, CA (US); Eric Shank, San Diego, CA (US)

Correspondence Address: James M. Stover;Intellectual Property Section, Law Department, NCR Corporation, 1700 South Patterson Blvd., Dayton, OH, 45479-0001, US

(21) Appl. No.: 11/564,896

(22) Filed: Nov. 30, 2006

(51) Int. Cl. G06F 12/02

(52) U.S. Cl. 711/154; 711/E12.002

(57) ABSTRACT

A method and system of reading data from a storage device. The storage device includes a plurality of physical storage extents. One or more of the storage extents is/are associated with a “void extent” indicator, a void extent being an extent that was the target of an unsuccessful write completion. In one technique a request is received to read the data from the storage device. The physical storage extent(s) on which the requested data is stored is located. If one of the located storage extents has an associated void extent indicator then a read error is returned. In a further technique, a request is received to read the data from the storage device. The physical storage extent(s) on which the requested data is stored is located. The data from the located storage extent(s) is retrieved if the read request is a diagnostic read and if the or one of the located storage extents has an associated void extent indicator. A read error is returned if the read request is a normal read, and if the or one of the located storage extents has an associated void extent indicator.

### BACKGROUND

Data organization is important in any database that deals with complex queries against large volumes of data. Disks or other storage devices on which the data is stored are generally divided into a set of “extents”. In a database system that includes a plurality of processing modules, individual processing modules have temporary control over one or more of the extents. Each extent is either temporarily owned by a processing module, or is free waiting to be allocated to a requesting processing module.

An allocation map controls the association of extents to processing module owners. When an extent is allocated, the allocator assigns a logical identifier to the extent and associates the logical identifier and the current owner with the extent by updating the allocation map.

There can be problems when an interrupted write occurs. In some systems, as soon as a processing module receives confirmation of allocation for a write request, the contents of the extent now owned by the processing module are indeterminate to the application. This means that if the extent returns an error or fails to respond, it is the responsibility of the application using the processing module to retry the write request until successful, or to initiate recovery of the data.

One partial solution is a full check sum of the entire extent. The problem with this approach is that check sums use storage capacity and processing power to generate and check Furthermore, check sums may not always align with the extent being written, creating vulnerabilities in this method.

### SUMMARY

Described below are methods of reading data from a storage device. The storage device includes a plurality of physical storage extents. One or more of the storage extents is/are associated with a void extent indicator.

In one technique a request is received to read the data from the storage device. The physical storage extent(s) on which the requested data is stored is located. If one of the located storage extents has an associated void extent indicator then a read error is returned.

In a further technique, a request is received to read the data from the storage device. The physical storage extent(s) on which the requested data is stored is located. The data from the located storage extent(s) is retrieved if the read request is a diagnostic read and if the or one of the located storage extents has an associated void extent indicator. A read error is returned if the read request is a normal read, and if the or one of the located storage extents has an associated void extent indicator.

Also described below are methods of writing data to a storage device. A request to write the data to the storage device is received. A request for allocation of a storage extent on the storage device is received from a requesting entity. A physical storage extent is allocated to the requesting entity. The data is written to the allocated storage extent. On detecting an unsuccessful writing of the data to the allocated storage extent, the allocated storage extent is associated with a void extent indicator.

The techniques also apply to logical storage extents.

### BRIEF DESCRIPTION OF THE DRAWINGS

FIG. 1 is a block diagram of an exemplary large computer system in which the techniques described below are implemented.

FIG. 2 is a flow chart of a preferred form method for handling read requests.

FIG. 3 is a flow chart of a preferred form method for handling write requests.

### DETAILED DESCRIPTION

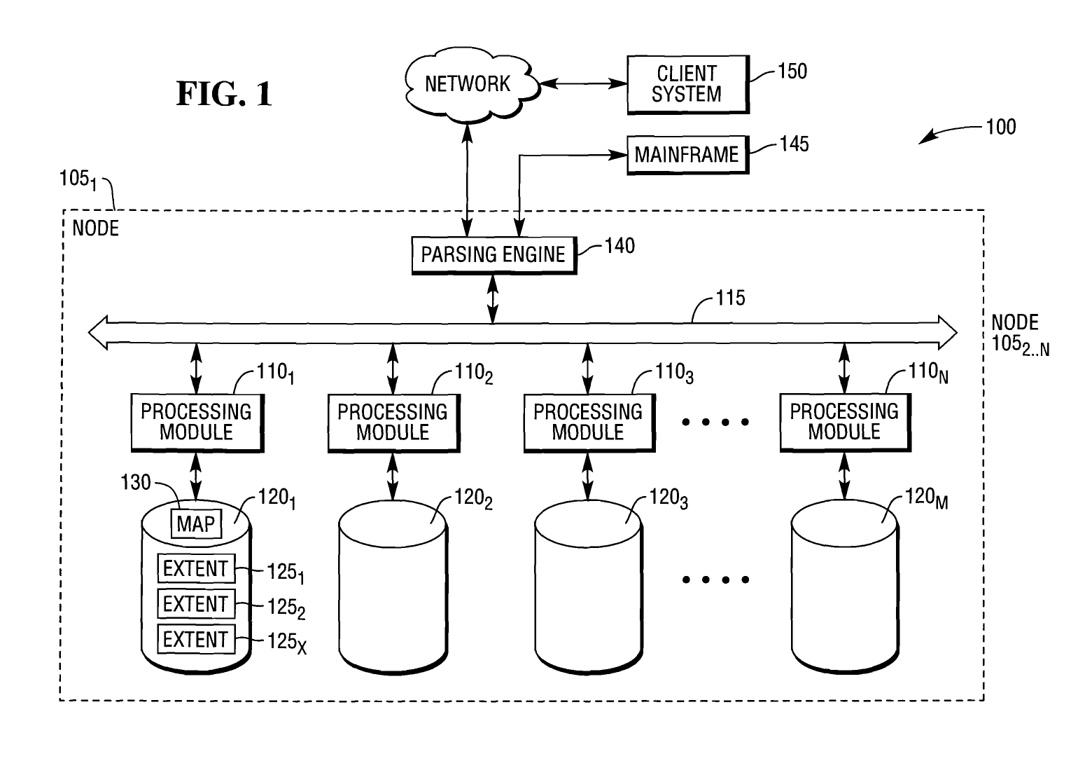

The techniques described in this specification have particular application but are not limited to large databases such as that shown in FIG. 1. These databases contain many millions or billions of records managed by a database system (DBS) 100, such as a Teradata active data warehousing system available from NCR Corporation. FIG. 1 shows a sample architecture for one node 105₁ of the DBS 100. The DBS node 105₁ includes one or more processing modules 110_{1 . . . N} connected by a network 115. The DBS may include multiple nodes 105_{2 . . . N} in addition to the illustrated node 105₁, connecting by extending the network 115.

The processing modules manage the storage and retrieval of data stored in data storage facilities 120_{1 . . . M} Each of the processing modules in one form comprise one or more physical processors. In another form they comprise one or more viral processors with one or more virtual processes running on one or more physical processors.

Each of the processing modules 110_{1 . . . N} manages a portion of a database that is stored in corresponding data storage facilities 120_{1 . . . M} Each of the data storage facilities 120_{1 . . . M} includes one or more disk drives. The storage facilities are divided into a set of physical extents. The extents each include a plurality of sectors (not shown). Storage facility 120₁ includes for example physical extents 125_{1 . . . X}.

Individual extents are owned by a requesting entity for the purpose of performing an input/output operation. Once a requesting entity has finished with the extent, the extent is released to be requested by another requesting entity. In the system shown in FIG. 1 processing modules 110 are examples of requesting entities. Processing module 110₁ for example requests or temporarily owns one or more extents 125_{1 . . . X}.

Individual extents are either owned by a requesting entity, or are free and available to be allocated to a requesting entity.

System 100 includes an allocation map 130 that is stored both on disk on one of the storage devices and in computer memory. The allocation map 130 controls the association of extents with requesting entities or owners. The map is managed by a software process called an allocator (not shown).

A parsing engine 140 in system 100 organizes the storage of data and the distribution of table rows among data extents within the processing modules 110_{1 . . . N}. The parsing engine 140 also coordinates the retrieval of data from the data storage facilities 120_{1 . . . M} in response to queries received from a user running an application on a mainframe 145 or a client computer 150. The DBS 100 usually receives queries and commands to build tables in a standard format such as SQL.

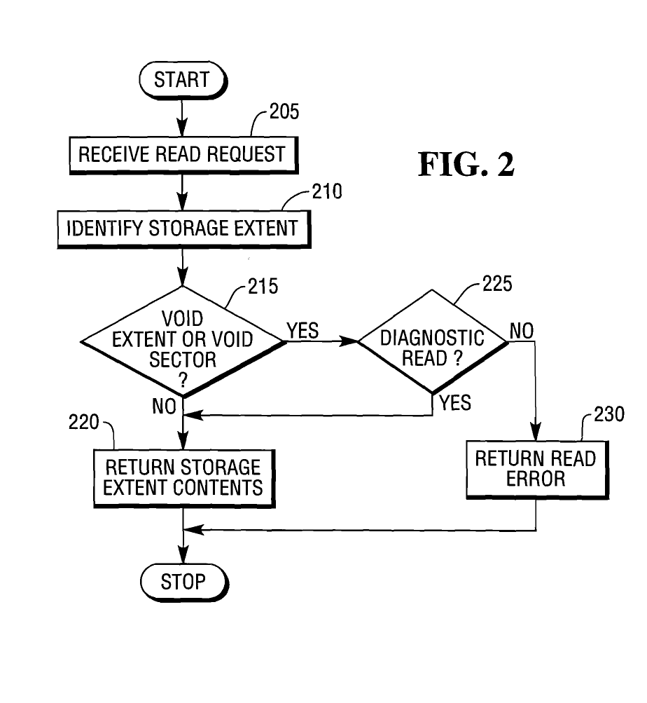

FIG. 2 illustrates a preferred form method for handling read requests from a storage device. The technique handles both logical and physical storage extents. The storage device in one form includes a plurality of physical storage extents. In another form the storage device additionally or alternatively includes a plurality of logical storage extents. Logical extents differ from physical storage extents in that logical extents have a variety of physical backing store arrangements.

System 100 receives a read request 205 to retrieve data from a logical or physical storage extent. The read request is either a normal read or a diagnostic read.

The relevant storage extent is identified 210 by either locating the physical storage exent on which the requested data is stored, or producing the data associated with a logical extent. There is generally a mapping between physical representations and logical representations that is used to produce the data associated with a logical extent.

The technique then checks for a void extent 215. Avoid extent is an extent that has previously been the target of an unsuccessful write operation. An unsuccessful write operation includes a write operation in which some sectors within an extent have been successfully written to, but that other sectors within the extent have been the target of an unsuccessful write operation. A void extent includes an extent in which one or more sectors within the extent are void.

If the relevant extent has not been labeled as a void extent, the data contents of the relevant storage extent are returned 220 as a result of the read to the requesting application. In one embodiment each sector is associated with a void extent indicator such as a void flag. A void flag set to true indicates that the associated sector is void.

If on the other hand the extent in question is labeled as a void extent, the information returned will depend on whether the read request is a normal read request or a diagnostic request.

As shown in FIG. 2, if the read request is a diagnostic read 225 then the contents or image of the storage extent are returned 220 to the application.

On the other hand if the read is a normal read then the read request returns 230 a read error. The return of this read error allows the physical atomicity and integrity and detection and recovery layer to robustly determine the proper course of action.

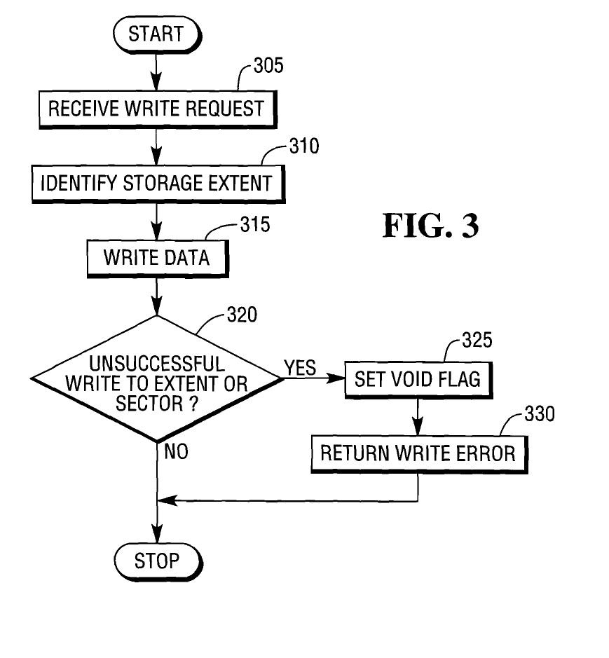

FIG. 3 illustrates a preferred form method for handling write requests to the storage device from FIG. 2. System 100 receives a write request 305 to write data to a logical or physical storage extent. The relevant storage extent is identified 310 by either locating the physical storage extent on which the requested data is stored, or producing the data associated with a logical extent.

The technique then attempts to write the data 315 to the identified storage extent. If the write is unsuccessful, for example if the extent cannot be written to 320, or only some sectors within the extent can be written to, then a void flag is set for example a void extent indicator that is associated with the extent. This could be performed by setting a void flag associated with one of the sectors within the extent to true. An extent that is a void extent can be then identified as one that has at least one sector marked as void. Following setting of the void flag a write error is returned 330 as a result of the unsuccessful write.

The text above describes one or more specific embodiments of a broader invention. The invention also is carried out in a variety of alternative embodiments and thus is not limited to those described here. Those other embodiments are also within the scope of the following claims.

1. A method of reading data from a storage device, the storage device including a plurality of physical storage extents, one or more of the storage extents associated with a void extent indicator, the method comprising:
receiving a request to read the data from the storage device;
locating the physical storage extent(s) on which the requested data is stored; and
if the or one of the located storage extents has an associated void extent indicator, returning a read error.

2. A method of reading data from a storage device, the storage device including a plurality of physical storage extents, one or more of the storage extents associated with a void extent indicator, the method comprising:
receiving a request to read the data from the storage device;
locating the physical storage extent(s) on which the requested data is stored;
retrieving the data from the located storage extent(s) if the read request is a diagnostic read and if the or one of the located storage extents has an associated void extent indicator, and
returning a read error if the read request is a normal read, and if the or one of the located storage extents has an associated void extent indicator.

3. A method of writing data to a storage device comprising the steps of:
receiving a request to write the data to the storage device;
receiving a request for allocation of a storage extent on the storage device from a requesting entity,
allocating a physical storage extent to the requesting entity,
writing the data to the allocated storage extent; and
on detecting an unsuccessful writing of the data to the allocated storage extent, associating the allocated storage extent with a void extent indicator.

4. A method of reading data from a storage device, the storage device including a plurality of logical storage extents, one or more of the storage extents associated with a void extent indicator, the method comprising:
receiving a request to read the data from the storage device;
producing the data associated with a logical extent; and
if the or one of the located storage extents has an associated void extent indicator, returning a read error.

5. A method of reading data from a storage device, the storage device including a plurality of logical storage extents, one or more of the storage extents associated with a void extent indicator, the method comprising:
receiving a request to read the data from the storage device;
producing the data associated with a logical extent;
producing the data from the located storage extent(s) if the read request is a diagnostic read and if the or one of the located storage extents has an associated void extent, indicator, and
returning a read error if the read request is a normal read and if the or one of the located storage extents has an associated void extent indicator.

6. A method of writing data to a storage device comprising the steps of:
receiving a request to write the data to the storage device;
receiving a request for allocation of a storage extent on the storage device from a requesting entity,
allocating a logical storage extent to the requesting entity,
writing the data to the allocated storage extent; and on detecting an unsuccessful writing of the data to the allocated storage extent, associating the allocated storage extent with a void extent indicator.
